(19) United States
(12) Patent Application Publication
(10) Pub. No.: US 2011/0150009 A1
(43) Pub. Date: Jun. 23, 2011

(54) POINTER PROCESSING APPARATUS AND POINTER PROCESSING METHOD

(75) Inventor: Toshiaki OHKUBO, Kawasaki (JP)

(73) Assignee: FUJITSU LIMITED, Kawasaki-shi (JP)

(21) Appl. No.: 12/974,000

(22) Filed: Dec. 21, 2010

(30) Foreign Application Priority Data
Dec. 22, 2009 (JP) 2009-290953

(51) Int. Cl. H04J 3/07

(52) U.S. Cl. 370/505

(57) ABSTRACT

A pointer processing apparatus includes a first synchronizing unit to bring a receive frame synchronized with a first clock into synchronization with a second clock, and a first stuffing unit to perform stuffing on the receive frame synchronized with the second clock, in accordance with a value of a pointer byte included in the receive frame.

### CROSS-REFERENCE TO RELATED APPLICATIONS

This application is based upon and claims the benefit of priority from the prior Japanese Patent Application No. 2009-290953 filed on Dec. 22, 2009, the entire contents of which are incorporated herein by reference.

### FIELD

The embodiments discussed herein are related to a pointer processing apparatus and a pointer processing method which are used in signal transmission over a synchronous network.

### BACKGROUND

FIG. 1 is a configuration diagram of a pointer processing unit in a SONET (Synchronous Optical Network)/SDH (Synchronous Digital Hierarchy) transmission apparatus according to the related art. The pointer processing unit 90 includes a first frame counter 91, a receive pointer processing unit 92, a storage unit 93, a first address generating unit 94, a second address generating unit 95, a phase comparison unit 96, a stuffing unit 97, and a pointer generating unit 98.

The pointer processing unit 90 receives a multiplex signal group including a plurality of multiplex signals dt#1 to dt#16 in a first format. The multiplex signals dt#1 to dt#16 in the first format are signals generated by demultiplexing a multiplex signal in a second format received by the SONET/SDH transmission apparatus. In the example of the pointer processing unit 90 illustrated in FIG. 1, the pointer processing unit 90 receives 16 STS-12 signals (corresponding to the multiplex signals in the first format) generated by demultiplexing an STS-192 signal (corresponding to the multiplex signal in the second format) received by the SONET/SDH transmission apparatus. Also, the pointer processing unit 90 receives a first timing signal indicative of a specified timing within each of frames in the individual multiplex signals.

The first frame counter 91 receives the first timing signal. On the basis of the first timing signal, the first frame counter 91 generates a first Synchronous Payload Envelope (SPE) enable signal, an H1 timing signal, an H2 timing signal, an H3 timing signal, an Increment (INC) timing signal, and channel slot information.

FIG. 2 is an explanatory diagram of an STS (Synchronous Transport Signal)-1 frame format. An STS-1 frame transmitted in a SONET transmission apparatus includes 3 bytes×3 rows of SOH (Section Over Head), 3 bytes×6 rows of LOH (Line Over Head), and 87 bytes×9 rows of payload. In the following description, the term “payload” is used to mean the payload of an STS frame.

LOH includes an H1 byte, an H2 byte, and an H3 byte that are pointer bytes. Also, addresses are assigned to individual bytes in the payload. An address “0” is assigned to the byte immediately following the H3 byte.

FIG. 3 is an explanatory diagram of an STS-12 frame format. An STS-12 frame is a frame obtained by multiplexing 12 STS-1 frames. In FIGS. 3, #1, and #2 to #12 indicate correspondence with the STS-1 frames before multiplexing. For example, information corresponding to an STS-1 frame #1 is stored at a position indicated by #1 in each of the H1, H2, and H3 bytes. Likewise, information corresponding to the STS-1 frame #1 is stored at a position indicated by #1 in the byte at address “0” in the payload.

Reference is now made to FIG. 1. The first SPE enable signal is a signal indicating the period during which the pointer processing unit 90 is receiving the payload of each of the multiplex signals dt#1 to dt#16. For example, the first SPE enable signal has the value “Enable” in the period during which the payload in each of the multiplex signals dt#1 to dt#16 is received, and has the value “Disable” in the other period.

The H1 timing signal is a signal indicating the timing at which the pointer processing unit 90 receives the H1 byte in each of the multiplex signals dt#1 to dt#16. Also, the H2 timing signal is a signal indicating the timing at which the pointer processing unit 90 receives the H2 byte. The H3 timing signal is a signal indicating the timing at which the pointer processing unit 90 receives the H3 byte. The INC timing signal is a signal indicating the timing at which the pointer processing unit 90 receives the next byte following the H3 byte, that is, the byte at address “0”. The channel slot information is a signal indicating the position of a frame included in each of the multiplex signals dt#1 to dt#16.

The receive pointer processing unit 92 receives the multiplex signals dt#1 to dt#16, the first SPE enable signal, the H1 timing signal, the H2 timing signal, the H3 timing signal, the inc timing signal, and the channel slot information.

The receive pointer processing unit 92 generates a second SPE enable signal, which is an enable signal that designates the write timing of the multiplex signals dt#1 to dt#16 to the storage unit 93. The receive pointer processing unit 92 extracts the H1 byte and the H2 byte in each of the multiplex signals dt#1 to dt#16 in accordance with the H1 timing signal and the H2 timing signal. The receive pointer processing unit 92 judges whether or not a positive stuff or negative stuff has been applied to a receive frame, in accordance with the H1 byte and the H2 byte.

When a positive stuff has been applied to the receive frame, in the period during which the next byte following the H3 byte is being received, the receive pointer processing unit 92 changes the value of the first SPE enable signal to “Disable” to thereby generate the second SPE enable signal. When a negative stuff has been applied to the receive frame, in the period during which the H3 byte is being received, the receive pointer processing unit 92 changes the value of the first SPE enable signal to “Enable” to thereby generate the second SPE enable signal. When no stuff has been applied to the receive frame, the receive pointer processing unit 92 outputs the first SPE enable signal as the second SPE enable signal.

Also, the receive pointer processing unit 92 generates a J1 timing signal indicating the timing at which a J1 byte stored in the receive frame is received, in accordance with the value of the H1 byte and the H2 byte. The receive pointer processing unit 92 detects the timing at which the J1 byte is received, by causing a counter to operate by the value of the pointer specified in the H1 byte and the H2 byte.

The receive pointer processing unit 92 sets the J1 timing signal to “Enable” only in the period during which the J1 byte is received, out of the period during which the pointer processing unit 90 is receiving the payload or the H3 byte. The J1 timing signal is outputted to the storage unit 93, and written to the storage unit 93 in synchronization with writing of the multiplex signals dt#1 to dt#16 to the storage unit 93.

A first clock and a second clock are supplied to the storage unit 93. The first clock is a clock generated by frequency-dividing a line clock extracted from a receive signal. Also, the second clock is a clock generated by frequency-dividing a reference clock supplied from a clock supplier of the SONET/SDH transmission apparatus. As the multiplex signals dt#1 to dt#16 are written to the storage unit 93 in synchronization with the first clock, and read from the storage unit 93 in synchronization with the second clock, the multiplex signals dt#1 to dt#16 are synchronized with the second clock. The storage unit 93 is used as a buffer for bringing the multiplex signals dt#1 to dt#16 into synchronization with the second clock.

The first address generating unit 94 generates a write address for writing each of the multiplex signals dt#1 to dt#16 and the J1 timing signal to the storage unit 93. The first address generating unit 94 generates the write address by causing the counter to operate in accordance with the second SPE enable signal.

The second address generating unit 95 generates a read address for reading each of the multiplex signals dt#1 to dt#16 and the J1 timing signal from the storage unit 93. The second address generating unit 95 generates the read address by causing the counter to operate in accordance with a fourth SPE enable signal generated by the stuffing unit 97 described later.

The phase comparison unit 96 compares between the phase of a write clock and the phase of a read clock with respect to the storage unit 93. Here, the term “write clock” refers to the portion of the first clock used in writing the multiplex signals dt#1 to dt#16 to the storage unit 93. The “phase of the write clock” is equal to the sum of phase shifts in the first clock occurring in the period during which the multiplex signals dt#1 to dt#16 are written to the storage unit 93. In other words, the phase of the write clock is equal to the sum of phase shifts in the first clock occurring in the period during which the value of the second SPE enable signal is “Enable”.

Also, the term “read clock” refers to the portion of the second clock used in reading the multiplex signals dt#1 to dt#16 from the storage unit 93. The “phase of the read clock” is equal to the sum of phase shifts in the second clock occurring in the period during which the multiplex signals dt#1 to dt#16 are read from the storage unit 93. In other words, the phase of the read clock is equal to the sum of phase shifts in the second clock occurring in the period during which the value of the fourth SPE enable signal is “Enable”.

If the phase difference between these phases does not fall within a specified range, the phase comparison unit 96 outputs a stuffing request signal for requesting a positive stuff or a negative stuff to the stuffing unit 97. The phase difference between the phase of the write clock and the phase of the read clock can be observed as the relative positions of the write address for writing each of the multiplex signals dt#1 to dt#16 to the storage unit 93 and the read address for reading each of the multiplex signals dt#1 to dt#16 from the storage unit 93. Accordingly, the first address generating unit 94 generates a phase comparison pulse whose value becomes “Enable” when the write address is within a specified range.

The phase comparison unit 96 compares the phase of the write clock with the phase of the read clock by receiving the phase comparison pulse and the fourth SPE enable signal, and judging the relative positions of the write address and read address.

The stuffing unit 97 receives a third SPE enable signal. The third SPE enable signal is a signal that specifies when to output pass data #1 to #16 from the pointer processing unit 90, in order to store the multiplex signals dt#1 to dt#16 into the payload of a transmit frame. The third SPE enable signal has the value “Enable” in the output period for storing the multiplex signals into the payload portion of the transmit frame, and has the value “Disable” in the other period.

The stuffing unit 97 generates the fourth SPE enable signal in accordance with the stuffing request signal. The fourth SPE enable signal indicates the timing at which data to be stored in the transmit frame is read from the storage unit 93. When a positive stuff is requested, the stuffing unit 97 generates the fourth SPE enable signal by changing the value of the third SPE enable signal to “Disable” in the period during which the next byte following the H3 byte is read. When a negative stuff is requested, the stuffing unit 97 generates the fourth SPE enable signal by changing the value of the third SPE enable signal to “Enable” in the period during which the H3 byte is read.

Also, upon performing stuffing, the stuffing unit 97 generates stuffing execution information indicating which one of a positive stuff and a negative stuff has been executed.

The pointer generating unit 98 generates a transmit pointer value indicating the address at which the J1 byte is stored in the transmit frame. The pointer generating unit 98 receives the stuffing execution information, the J1 timing signal read from the storage unit 93, the fourth SPE enable signal, and a second timing signal. The second timing signal is a signal indicating the timing at which data to be stored at address “0” in the transmit frame is read from the storage unit 93.

The pointer generating unit 98 causes the counter to operate in accordance with the fourth SPE enable signal, between the respective timings indicated by the J1 timing signal and the second timing signal. The pointer generating unit 98 generates a transmit pointer value by adjusting the obtained count in accordance with the presence/absence and kind of stuffing.

There has been proposed a pointer processing apparatus including an overhead termination unit that performs overhead termination for an input signal, a clock switching unit that switches the output of the overhead termination unit from the one based on a clock on the overhead termination side to the one based on a clock on the pointer processing side, and a pointer processing unit that performs pointer processing by time division for the output of the overhead termination unit which has been switched in the clock switching unit to the one based on the clock on the pointer processing side.

Also, there has been proposed a pointer processing apparatus including a pointer serialization unit that serializes each pointer data in a plurality of multiplex signals received in parallel, and a common pointer processing unit that performs receive pointer processing commonly with respect to each of the multiplex signals on the basis of the pointer data serialized by the pointer serialization unit. This common pointer processing unit supplies the processing results of pointer processing on each of the multiplex signals, serially to a plurality of main signal processors that apply specified processing to the main signal of each multiplex signal on the basis of the processing results.

This pointer processing apparatus includes a concatenation head channel copy unit. When a multiplex signal has a concatenation structure having head channel data and subordinate channel data subordinate to the head channel data, the concatenation head channel copy unit serially receives the above-mentioned pointer processing results from the common pointer processing unit, and copies and outputs the pointer processing results on the head channel data to the main signal processors as the pointer processing results on the subordinate channel data.

As the related art, there are techniques described in Japanese Laid-open Patent Publication No. 08-79231, and Japanese Laid-open Patent Publication No. 2000-41012.

### SUMMARY

According to an aspect of the invention, a pointer processing apparatus includes a first synchronizing unit to bring a receive frame synchronized with a first clock into synchronization with a second clock, and a first stuffing unit to perform stuffing on the receive frame synchronized with the second clock, in accordance with a value of a pointer byte included in the receive frame.

The object and advantages of the invention will be realized and attained by at least the elements, features, and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a pointer processing unit according to the related art.

FIG. 2 is an explanatory diagram of an STS-1 frame format.

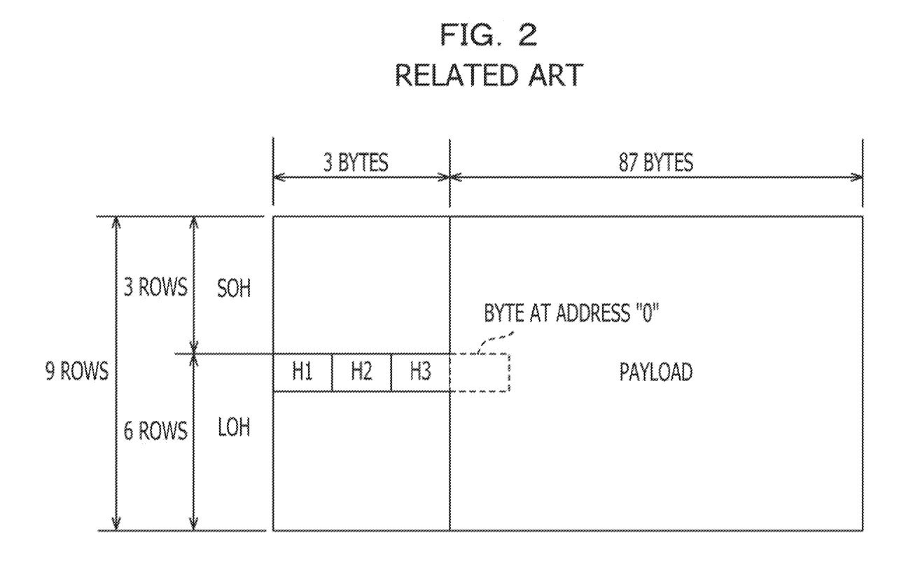

FIG. 3 is an explanatory diagram of an STS-12 frame format.

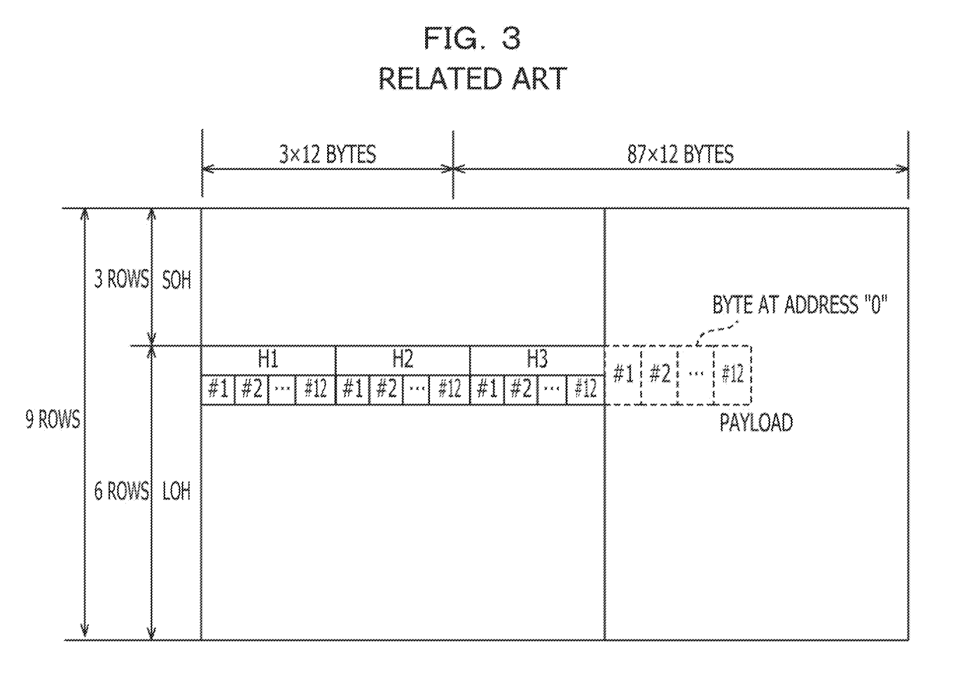

FIG. 4 is a configuration diagram of an embodiment of a SONET/SDH transmission apparatus.

FIG. 5 is a configuration diagram (Part 1) of the pointer processing unit illustrated in FIG. 4.

FIG. 6 is a configuration diagram (Part 2) of the pointer processing unit illustrated in FIG. 4.

FIG. 7 is an explanatory diagram of the range of an STS-12 frame which is stored into a first storage unit.

### DESCRIPTION OF EMBODIMENTS

Pointer processing apparatuses according to the related perform stuffing based on the pointer bytes of a received multiplex signal, prior to bringing the multiplex signal synchronized with a first clock into synchronization with a second clock. As used herein, the term “stuffing” refers to the addition or subtraction of bits from a buffer. Or, SONET/SDH Byte Sfuffing. For example, when reading the multiplex signal in synchronization with the second clock after writing the multiplex signal to a buffer, in the case of a positive stuff, writing of a byte at the next position following the H3 byte is skipped. That is, in the case of a negative stuff, in addition to the payload, the H3 byte is also written to the buffer.

The presence/absence of stuffing in a received multiplex signal differs for each of signals multiplexed in the multiplex signal. Therefore, the phase of a write clock used in writing the multiplex signal to a buffer differs for each of multiplexed signals. As a result, pointer processing apparatuses according to the related art includes, for each of signals to be multiplexed, a phase comparison circuit for comparing the phase of a write clock and the phase of a read clock used in reading the multiplex signal from the buffer.

Hereinbelow, embodiments will be described with reference to the attached drawings.

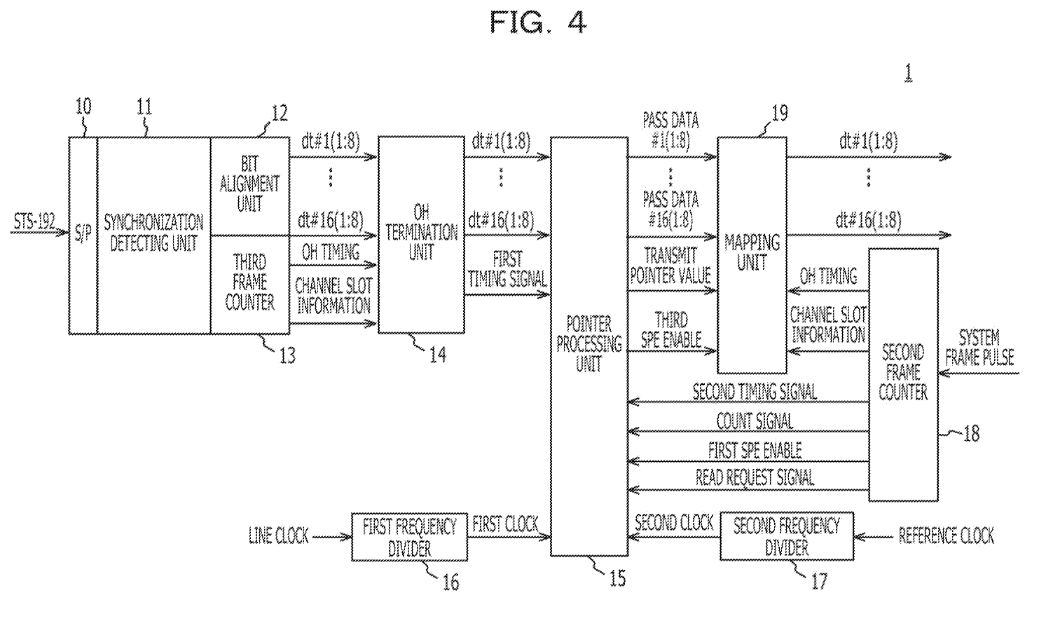

FIG. 4 is a configuration diagram of an embodiment of a SONET/SDH transmission apparatus. FIG. 4 illustrates the portion of the actual configuration of the SONET/SDH transmission apparatus which is related to the explanation of the embodiment. Also, in the following description, an STS-192 signal is exemplified as a multiplex signal transmitted in the SONET/SDH transmission apparatus according to the embodiment. However, the multiplex signal transmitted in the SONET/SDH transmission apparatus according to the embodiment may be a signal at another bit rate.

A SONET/SDH transmission apparatus 1 has a serial/parallel converter (S/P) 10, a synchronization detector 11, a bit alignment unit 12, a third frame counter 13, and an overhead (OH) termination unit 14. Also, the SONET/SDH transmission apparatus 1 includes a pointer processing unit 15, a first frequency divider 16, a second frequency divider 17, a second frame counter 18, and a mapping unit 19.

The serial/parallel converter 10 converts an STS-192 signal that is a multiplex signal in a second format, which includes a plurality of (in this embodiment, 16) STS-12 signals dt#1 to dt#16 that are multiplex signals in a first format, into a signal in a parallel format. The synchronization detector 11 detects frame synchronization of the STS-192 signal. The bit alignment unit 12 demultiplexes the STS-192 signal in accordance with the detected frame synchronization, thereby generating the 16 STS-12 signals dt#1 to dt#16. In the following description, the multiplex signals dt#1 to dt#16 received by the SONET/SDH transmission apparatus 1 are sometimes denoted as “receive multiplex signals dt#1 to dt#16”. Also, an STS frame included in each receive multiplex signal is sometimes denoted as “receive frame”.

The third frame counter 13 generates an overhead (OH) timing signal, and channel slot information in accordance with the detected frame synchronization. The overhead timing signal is a timing signal indicating the start timing of SOH and the start timing of LOH in each of the receive multiplex signals dt#1 to dt#16. The channel slot information is a signal indicating a position of a frame included in each of the receive multiplex signals dt#1 to dt#16.

The overhead termination unit 14 receives the receive multiplex signals dt#1 to dt#16, the overhead timing signal, and the channel slot information, and generates a first timing signal indicating a specified timing within each of frames in the receive multiplex signals dt#1 to dt#16. The first frequency divider 16 generates a first clock by frequency-dividing a line clock extracted from each receive signal. Also, the second frequency divider 17 generates a second clock by frequency-dividing a reference clock supplied from a clock supplier provided in the SONET/SDH transmission apparatus 1.

The pointer processing unit 15 synchronizes the receive multiplex signals dt#1 to dt#16 with the second clock, and outputs the signals as pass data #1 to pass data #16, respectively. The pass data #1 to the pass data #16 are data of virtual containers respectively stored in the receive multiplex signals dt#1 to dt#16.

Also, the pointer processing unit 15 generates a transmit pointer value, and a third SPE enable signal. The transmit pointer value indicates an address at which the J1 byte of each of the pass data #1 to the pass data #16 is stored in each of the multiplex signals dt#1 to dt#16 transmitted from the SONET/SDH transmission apparatus 1. In the following description, the multiplex signals dt#1 to dt#16 transmitted from the SONET/SDH transmission apparatus 1 are sometimes denoted as “transmit multiplex signals dt#1 to dt#16”. Also, an STS frame included in each transmit multiplex signal is sometimes denoted as “transmit frame”.

The third SPE enable signal indicates the period during which the pass data #1 to the pass data #16 to be stored in the transmit frame are read from a first storage unit 21 in the pointer processing unit 15 described later. As will be described later, the first storage unit 21 is a storage element for storing the receive multiplex signals dt#1 to dt#16 inputted to the pointer processing unit 15. For example, the third SPE enable signal may have the value “Enable” in the period during which the pass data #1 to the pass data #16 are read, and have the value “Disable” in the other period. The configuration and operation of the pointer processing unit 15 will be further described later.

The second frame counter 18 receives a system frame pulse. The system frame pulse indicates a reference timing for the timing at which to transmit multiplex signals from the SONET/SDH transmission apparatus 1. The second frame counter 18 generates, in accordance with the timing indicated by the system frame pulse, an overhead (OH) timing signal, channel slot information, a second timing signal, a count signal, a first SPE enable signal, and a read request signal.

The overhead timing signal is a timing signal indicating the start timing of SOH and the start timing of LOH in each of the transmit multiplex signals dt#1 to dt#16. That is, the overhead timing signal is a signal indicating a position of a frame included in each of the transmit multiplex signals dt#1 to dt#16.

The second timing signal is a signal indicating a specified timing within each of frames in the transmit multiplex signals dt#1 to dt#16. The count signal indicates a count outputted from a counter that performs a counting operation in synchronization with the second clock or reference clock. The count signal may be, for example, a signal that is incremented by the second clock to sequentially indicate each position within the transmit frame.

The first SPE enable signal is a signal that specifies, with respect to the pointer processing unit 15, when to output the pass data #1 to #16 from the pointer processing unit 15, in order to store the pass data #1 to #16 into the payload portion of the transmit frame. For example, the first SPE enable signal may have the value “Enable” in the output period for storing the pass data into the payload portion of the transmit frame, and have the value “Disable” in the other period.

The read request signal is a signal for requesting that the translation results of pointer bytes included in the receive multiplex signals dt#1 to dt#16 be read from a forth storage unit 29 in the pointer processing unit 15 described later. The fourth storage unit 29 is a storage element for storing the results of translation of the pointer bytes included in the receive multiplex signals dt#1 to dt#16. The translation results of the pointer bytes are used for computing a transmit pointer value, and judging whether or not stuffing has been applied to the receive multiplex signals dt#1 to dt#16.

The mapping unit 19 receives the pass data #1 to the pass data #16, the transmit pointer value, and the third SPE enable signal from the pointer processing unit 15. Also, the mapping unit 19 receives the overhead timing signal, and the channel slot information from the second frame counter. The mapping unit 19 maps the pass data #1 to the pass data #16 and overhead information to the transmit frame in accordance with the overhead timing signal and the channel slot information.

The mapping unit 19 judges the timing at which the pass data #1 to the pass data #16 are outputted from the pointer processing unit 15, in accordance with the third SPE enable signal. The mapping unit 19 applies stuffing to the transmit frame, depending on whether the value of the third SPE enable signal is “Enable” at the timing corresponding to the H3 byte or the next byte following the H3 byte of the transmit frame. Also, the mapping unit 19 determines the pointer bytes to be inserted in the transmit frame, in accordance with the transmit pointer value.

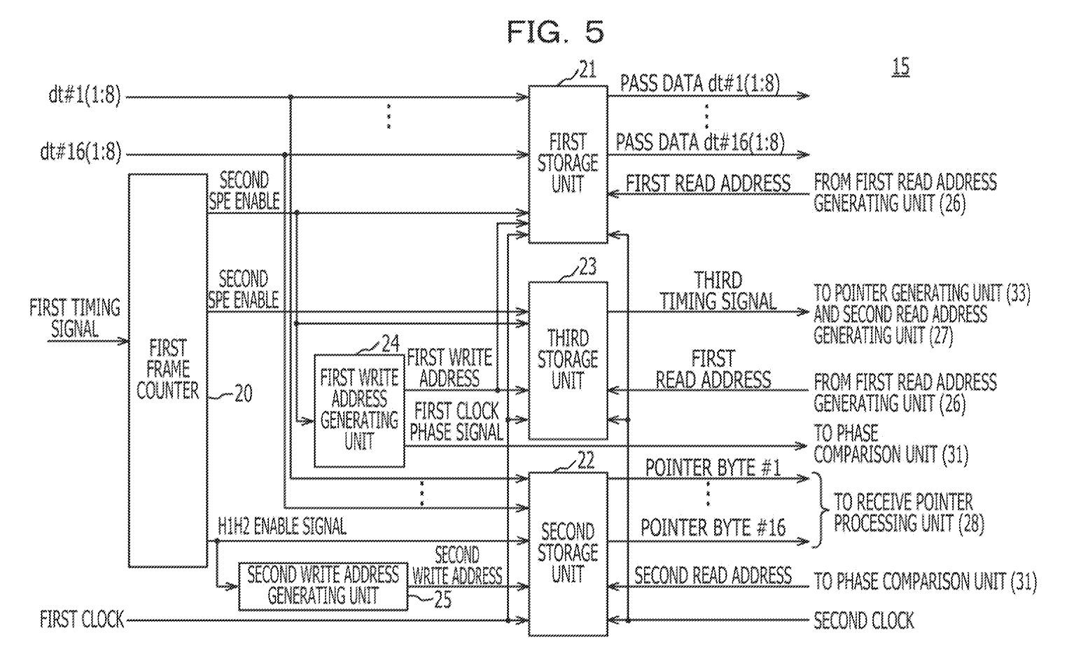

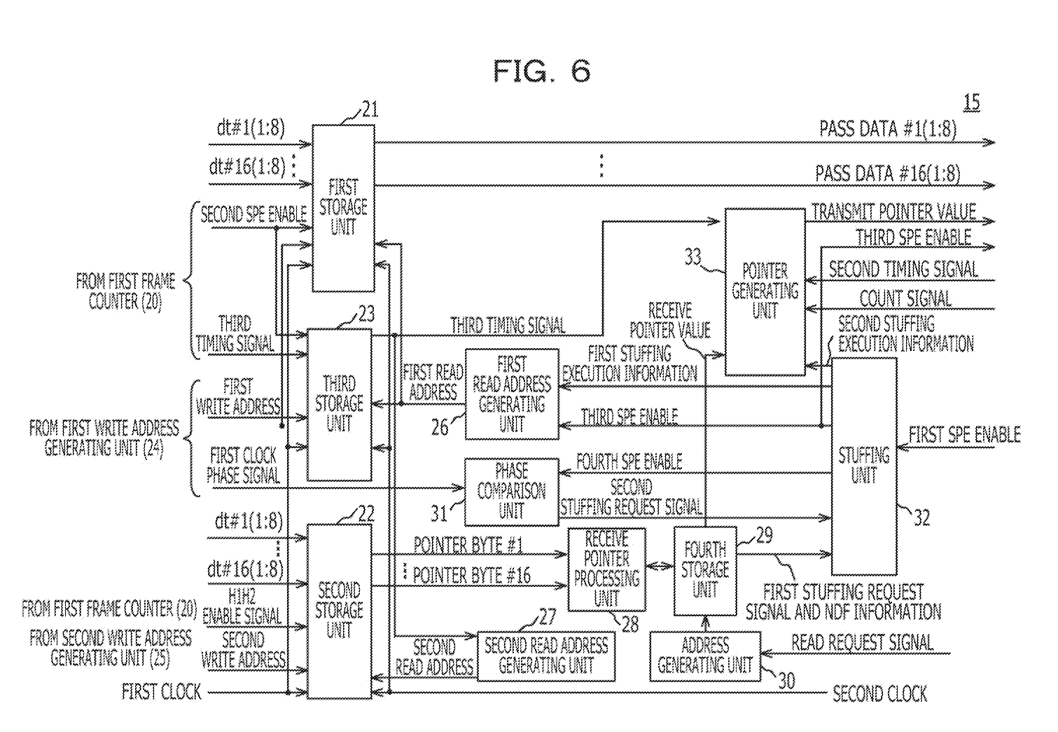

FIG. 5 and FIG. 6 are each a configuration diagram of the pointer processing unit 15 illustrated in FIG. 4. The pointer processing unit 15 includes a first frame counter 20, the first storage unit 21, a second storage unit 22, a third storage unit 23, a first write address generating unit 24, and a second write address generating unit 25. Also, the pointer processing unit 15 includes a first read address generating unit 26, a second read address generating unit 27, a receive pointer processing unit 28, the fourth storage unit 29, an address generating unit 30, a phase comparison unit 31, a stuffing unit 32, and a pointer generating unit 33.

The first frame counter 20 receives the first timing signal outputted from the overhead termination unit 14. The first frame counter 20 generates a second SPE enable signal, a third timing signal, and an H1H2 enable signal, in accordance with the first timing signal.

The second SPE enable signal is a signal indicating the period during which a range of data to be stored into the first storage unit 21 out of data included in the receive frame is received by the pointer processing unit 15.

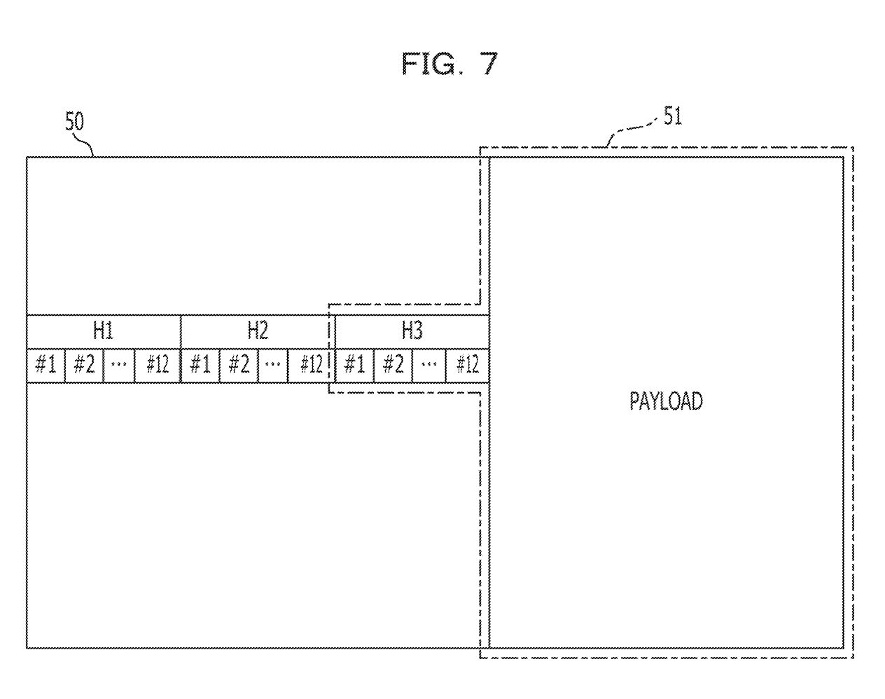

FIG. 7 illustrates the range of data to be stored into the first storage unit 21 in the case when the receive multiplex signals dt#1 to dt#16 are STS-12 signals. A range 51 including the payload and the H3 byte, out of an STS-12 frame 50, is stored into the first storage unit 21. Therefore, the second SPE enable signal indicates the period during which the payload or H3 byte of the receive frame is received by the pointer processing unit 15. For example, the second SPE enable signal may have the value “Enable” in the period during which the payload or H3 byte is received, and have the value “Disable” in the other period.

Reference is now made to FIG. 5. The third timing signal is a signal indicating a specified timing within the receive frame. The third timing signal may be determined so as to indicate a timing preceding the receiving timing of the H1 byte. For example, the third timing signal may be a signal that has the value “Enable” only during a specified period in the receive frame.

The H1H2 enable signal is a signal that has the value “Enable” in a period during which the H1 byte or H2 byte of each of the receive multiplex signals dt#1 to dt#16 is received, and has the value “Disable” in the other period.

The first storage unit 21 receives the second SPE enable signal as a write enable signal. While the second SPE enable signal has the value “Enable”, the receive multiplex signals dt#1 to dt#16 are written to the first storage unit 21 in synchronization with the first clock. A first write address used as a write address in the first storage unit 21 is generated by the first write address generating unit 24.

The second storage unit 22 receives the H1H2 enable signal as a write enable signal. Pointer bytes, that is, the H1 byte and the H2 byte are written to the second storage unit 22 in synchronization with the first clock, for each of the receive multiplex signals dt#1 to dt#16. A second write address used as a write address in the second storage unit 22 is generated by the second write address generating unit 25.

The third storage unit 23 receives the second SPE enable signal as a write enable signal. While the second SPE enable signal has the value “Enable”, the third timing signal is written to the third storage unit 23 in synchronization with the first clock. In other words, the third timing signal is written to the third storage unit 23 in synchronization with writing of the receive multiplex signals dt#1 to dt#16 to the first storage unit 21. The first write address is also used as a write address in the third storage unit 23.

The first write address generating unit 24 generates the first write address by causing the counter to operate in accordance with the second SPE enable signal. Also, the first write address generating unit 24 generates a first clock phase signal indicating the phase of the first clock, and outputs the first clock phase signal to the phase comparison unit 31. A further description of the first clock phase signal will be given later. The second write address generating unit 25 generates the second write address by causing the counter to operate in accordance with the H1H2 enable signal.

Reference is now made to FIG. 6. The receive multiplex signals dt#1 to dt#16 stored in the first storage unit 21 are read in synchronization with the second clock. A first read address used as a read address in the first storage unit 21 is generated by the first read address generating unit 26. The signals read from the first storage unit 21 from the first read address generated by the first read address generating unit 26 are outputted to the mapping unit 19 illustrated in FIG. 4 as the pass data #1 to #16.

The third timing signal stored in the third storage unit 23 is read in synchronization with the second clock. The first read address is also used as a read address in the third storage unit 23. Therefore, the third timing signal is read from the third storage unit 23 in synchronization with reading of the receive multiplex signals dt#1 to dt#16 from the first storage unit 21.

The pointer bytes stored in the second storage unit 22 are read in synchronization with the second clock. A second read address used as a read address in the second storage unit 22 is generated by the second read address generating unit 27.

The first read address generating unit 26 receives first stuffing execution information, and the third SPE enable signal from the stuffing unit 32. The first stuffing execution information indicates whether or not stuffing has been applied to the receive multiplex signals dt#1 to dt#16 stored in the first storage unit 21.

The first read address generating unit 26 generates the first read address by causing the counter to operate in accordance with the third SPE enable signal. Then, if positive stuffing has been applied to the receive multiplex signals dt#1 to dt#16, the first read address generating unit 26 advances the first read address in such a way as to skip the addresses at which the H3 byte and the next byte following the H3 byte are stored.

On the other hand, if stuffing has not been applied to the receive multiplex signals dt#1 to dt#16, the first read address generating unit 26 advances the first read address in such a way as to skip the address at which the H3 byte is stored. If negative stuffing has been applied to the receive multiplex signals dt#1 to dt#16, the first read address generating unit 26 does not skip the address, so the H3 byte is also read as a part of pass data.

The second read address generating unit 27 generates the second read address, with the timing indicated by the third timing signal read from the third storage unit 23 as a trigger. As described above, the third timing signal may be determined so as to indicate a timing preceding the receiving timing of the H1 byte.

The pointer bytes stored in the second storage unit 22 are used for stuffing by the receive pointer processing unit 28 and the stuffing unit 32, and for the calculation of a transmit pointer value by the pointer generating unit 33. Accordingly, the third timing signal may be determined so as to precede the receiving timing of the H1 byte by a specified margin, so that reading of the pointer bytes from the second storage unit 22 is completed in time for these stuffing and calculation.

The receive pointer processing unit 28 translates the pointer bytes read from the second storage unit 22, on the basis of the translation results of the pointer bytes of the preceding frame stored in the fourth storage unit 29. The receive pointer processing unit 28 stores the translation result of the pointer bytes to the fourth storage unit 29. The translation results of the pointer bytes are supplied to the stuffing unit 32 in the form of a first stuffing request signal and NDF (New Data Flag) information. Also, the translation results of the pointer bytes are supplied to the pointer generating unit 33 in the form of a receive pointer value.

The first stuffing request signal is a signal that requests the stuffing unit 32 to apply stuffing also to the transmit multiplex signals dt#1 to dt#16 because stuffing has been applied to the receive multiplex signals dt#1 to dt#16. The NDF information is information indicating that the NDF of the pointer bytes in the receive frame is Enable. The receive pointer value is a pointer value indicated by the pointer bytes in the receive frame.

The address generating unit 30 generates a write address for writing the translation results of the pointer bytes to the fourth storage unit 29. Also, the address generating unit 30 generates a read address for reading the translation results of the pointer bytes from the fourth storage unit 29, in accordance with a read request signal generated by the second frame counter 18 illustrated in FIG. 4.

The phase comparison unit 31 compares the phase of the first clock with the phase of the second clock, and judges whether or not it is required to perform stuffing for absorbing a velocity error between the first clock and the second clock. When the phase difference between the first clock and the second clock does not fall within a specified range, the phase comparison unit 31 outputs a second stuffing request signal that requests the stuffing unit 32 to perform stuffing on the transmit multiplex signals dt#1 to dt#16.

The phase comparison unit 31 may detect, for example, the difference between the count of the first clock and the count of the second clock, as the phase difference between the first clock and the second clock. At this time, the first write address generating unit 24 outputs the count of the first clock to the phase comparison unit 31 as the first clock phase signal.

Also, for example, the phase comparison unit 31 may detect the difference between the phase of a write clock and the phase of a read clock described below, as the phase difference between the first clock and the second clock. In this regard, the “phase of the write clock” is the sum of phase shifts in the first clock occurring in the period during which the receive multiplex signals dt#1 to dt#16 are written to the first storage unit 21. In other words, the phase of the write clock is equal to the sum of phase shifts in the first clock used in writing the receive multiplex signals dt#1 to dt#16 to the first storage unit 21.

Also, the “phase of the read clock” is the sum of phase shifts in the second clock occurring in the period during which a fourth SPE enable signal mentioned below has the value “Enable”. The fourth SPE enable signal is generated by changing the length of the period during which the first SPE enable signal has the value “Enable” in the manner as described below in accordance with the second stuffing request signal.

When the second stuffing request signal requests a positive stuff, the length of the period during which the fourth SPE enable signal has the value “Enable” is equal to the length of the period during which the first SPE enable signal has the value “Enable”.

When there is no stuff request by the second stuffing request signal, the length of the period during which the fourth SPE enable signal has the value “Enable” is longer than the length of the period during which the first SPE enable signal has the value “Enable” by one clock cycle.

When the second stuffing request signal requests a negative stuff, the length of the period during which the fourth SPE enable signal has the value “Enable” is longer than the length of the period during which the first SPE enable signal has the value “Enable” by two clock cycles.

At this time, the first write address generating unit 24 outputs information indicating the phase of the write clock to the phase comparison unit 31 as the first clock phase signal. The first clock phase signal may be, for example, a pulse signal whose value becomes “Enable” when the first write address is within a specified range. Also, the phase comparison unit 31 may detect the phase of the read clock by counting the second clock in accordance with the fourth SPE enable signal described below.

The stuffing unit 32 receives the first SPE enable signal, the first stuffing request signal, and the second stuffing request signal. The stuffing unit 32 judges whether or not to apply stuffing to the transmit multiplex signals dt#1 to dt#16, in accordance with the first stuffing request signal and the second stuffing request signal. The stuffing unit 32 generates the first stuffing execution information, the second stuffing execution information, the third SPE enable signal, and the fourth SPE enable signal.

The first stuffing execution information is information indicating that stuffing is to be applied to the transmit multiplex signals dt#1 to dt#16 in response to the request made by the first stuffing request signal. In other words, the first stuffing execution information indicates that stuffing has been applied to the receive multiplex signals dt#1 to dt#16, and hence stuffing is to be applied also to the transmit multiplex signals dt#1 to dt#16. The stuffing unit 32 outputs the first stuffing execution information to the first read address generating unit 26 when performing stuffing in response to the request made by the first stuffing request signal.

On the other hand, the second stuffing execution information is information indicating that stuffing is to be applied to the transmit multiplex signals dt#1 to dt#16 in response to either of the first stuffing request signal and the second stuffing request signal. The stuffing unit 32 outputs the second stuffing execution information to the pointer generating unit 33 when performing stuffing.

When positive stuffing is performed, the stuffing unit 32 generates the third SPE enable signal by changing the value of a period corresponding to the position of the next byte following the H3 byte in the first SPE enable signal to “Disable”. When negative stuffing is performed, the stuffing unit 32 generates the third SPE enable signal by changing the value of a period corresponding to the position of the H3 byte in the first SPE enable signal to “Enable”.

When both the first stuffing request signal and the second stuffing request signal simultaneously request a positive stuff, or when both the first stuffing request signal and the second stuffing request signal simultaneously request a negative stuff, the stuffing unit 32 preferentially executes the stuffing requested by the first stuffing request signal. In other words, the stuffing unit 32 gives priority to the stuffing resulting from the stuffing applied to the receive multiplex signals dt#1 to dt#16.

To comply with the SONET/SDH standard, once stuffing is performed, the stuffing unit 32 prohibits stuffing in the three subsequent frames. Accordingly, while stuffing is prohibited, the stuffing unit 32 stores information indicating that there has been a request for stuffing by the second stuffing request signal. The stuffing unit 32 executes the stuffing based on the second stuffing request signal in the fourth frame following the frame in which stuffing is performed. At this time, if there is a race between this request and the request made by the first stuffing request signal again at this time, the stuffing unit 32 further defers the stuffing based on the second stuffing request signal to a later time.

When stuffing based on the first stuffing request signal is requested within three frames after given stuffing is performed, the stuffing unit 32 prohibits the stuffing requested by the first stuffing request signal. While the stuffing is prohibited, the stuffing unit 32 stores information indicating that there has been a request for stuffing by the first stuffing request signal.

At this time, the stuffing unit 32 outputs to the first read address generating unit 26 a signal indicating that the stuffing requested by the first stuffing request signal is being prohibited. The first read address generating unit 26 corrects the skipping location of the first read address in accordance with the stuffing requested by the first stuffing request signal. By correcting the skipping location of the first read address, virtual container data is read properly from the first storage unit 21. The stuffing unit 32 executes the stuffing based on the first stuffing request signal in the fourth frame following the frame in which stuffing is performed.

On the other hand, when the first stuffing request signal requests one of a positive stuff and a negative stuff, and the second stuffing request signal requests the other, to omit execution of stuffing, the stuffing unit 32 stops output of the second stuffing execution information. It should be noted, however, that even in this case, the stuffing unit 32 outputs the same first stuffing execution information as that when executing the stuffing requested by the first stuffing request signal, to the first read address generating unit 26, and causes a normal first read address to be generated. Also, in the same manner as when executing stuffing requested by the second stuffing request signal, the stuffing unit 32 generates the fourth SPE enable signal.

The pointer generating unit 33 receives the second timing signal, the third timing signal, the receive pointer value, the count signal, and the second stuffing execution information. As mentioned above, the second timing signal is a signal indicating a specified timing within the transmit frame. Also, the third timing signal is a timing signal indicating a specified timing within the receive frame.

The pointer generating unit 33 compares the value of the count signal received at the timing indicated by the second timing signal, with the value of the count signal received at the timing indicated by the third timing signal. Through comparison between the values of these count signals, the pointer generating unit 33 detects a difference in address between the position where each of the pass data #1 to #16 read from the first storage unit 21 is stored in the receive frame, and the position where each of the pass data #1 to #16 is to be stored in the transmit frame. It should be noted that for the simplicity of calculation, the second and third timing signals may be generated in such a way that the interval between the start point of the transmit frame and the timing indicated by the third timing signal, and the interval between the start point of the receive frame and the timing indicated by the second timing signal become the same.

The pointer generating unit 33 adjusts the receive pointer on the basis of the detected difference in address. The pointer generating unit 33 adjusts the receive pointer depending on whether a positive stuff or a negative stuff has been performed, in accordance with the second stuffing execution information, thereby calculating the transmit pointer value. Also, when the NDF of the pointer bytes in the receive frame is Enable, the pointer generating unit 33 outputs the value of the receive pointer adjusted on the basis of the difference in address, as the transmit pointer value.

In this way, when stuffing has been applied to the receive multiplex signals dt#1 to dt#16, the stuffing unit 32 and the mapping unit 19 apply stuffing to the multiplex signals dt#1 to dt#16 that are stored in the first storage unit 21 and read in synchronization with the second clock. Therefore, irrespective of whether or not stuffing has been applied to the receive frame, the multiplex signals dt#1 to dt#16 of the fixed range 51 illustrated in FIG. 7 are stored into the first storage unit 21.

As a result, the phase of the first clock to be compared with the phase of the second clock in the phase comparison unit 31 becomes equal among individual signals multiplexed in a multiplex signal. Therefore, according to this embodiment, the phase comparison circuit that is provided for each of multiplexed signals in the related art can be shared among the multiplexed signals, thereby reducing the circuit scale of the pointer processing unit 15.

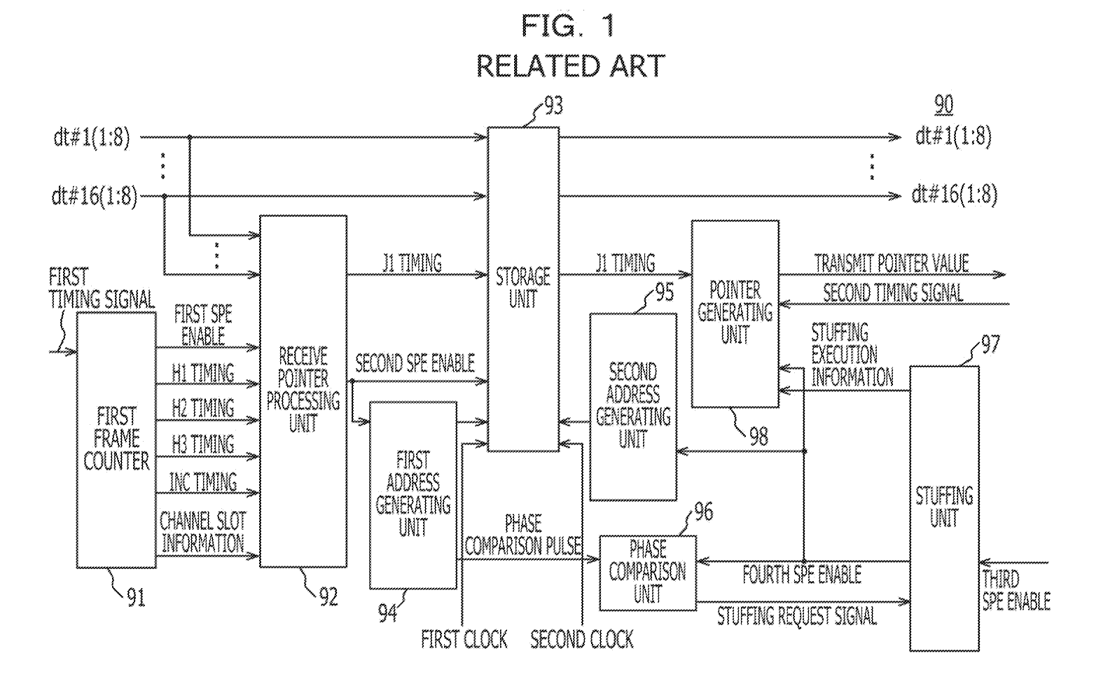

Also, as described above, in the pointer processing unit 90 according to the related art illustrated in FIG. 1, the receive pointer processing unit 92 is provided with a counter in order to generate the J1 timing signal. Also, the pointer generating unit 98 is also provided with a counter in order to generate a transmit pointer value from the difference between the timing indicated by the J1 timing signal read from the storage unit 93 and the timing indicated by the second timing signal. According to this embodiment, the pointer generating unit 33 generates a transmit pointer value by using the value of the count signal outputted from the second frame counter, thereby obviating counters provided in the related art. Therefore, the circuit scale of the pointer processing unit 15 is further reduced.

Also, according to this embodiment, the further reduction in the circuit scale of the pointer processing unit 15 also enables a reduction in the consumption of power by the pointer processing unit 15.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A pointer processing apparatus, comprising:
a first synchronizing unit to bring a receive frame synchronized with a first clock into synchronization with a second clock; and
a first stuffing unit to perform stuffing on the receive frame synchronized with the second clock, in accordance with a value of a pointer byte included in the receive frame.

2. The pointer processing apparatus according to claim 1, further comprising:
a phase comparison unit to compare a phase of the first clock with a phase of the second clock; and
a second stuffing unit to perform stuffing on the receive frame synchronized with the second clock, when a phase difference between the first clock and the second clock does not fall within a specified range.

3. The pointer processing apparatus according to claim 1, wherein:
the first synchronizing unit has
a first storage unit to which data is written in synchronization with the first clock, and from which data is read in synchronization with the second clock, and
a first address determining unit to determine an address from which to read data from the first storage unit;
a payload and an H3 byte of the receive frame are written to the first storage unit; and
the first address determining unit to determine a range of address from which to read data from the first storage unit in accordance with a value of the pointer byte.

4. The pointer processing apparatus according to claim 3, further comprising:
a second storage unit to which the pointer byte included in the receive frame synchronized with the first clock is written; and
a second address determining unit to determine an address from which to read the pointer byte from the second storage unit, prior to the stuffing by the first stuffing unit.

5. The pointer processing apparatus according to claim 4, further comprising:
a third storage unit to which a timing signal indicating a specified timing within the receive frame is written in synchronization with writing of the receive frame to the first storage unit, and from which the timing signal is read in synchronization with reading of the receive frame from the first storage unit,
wherein the second address determining unit determines a read address in the second storage unit at the timing indicated by the timing signal read from the third storage unit.

6. The pointer processing apparatus according to claim 1, further comprising:
a second synchronizing unit to bring a timing signal indicating a specified timing within the receive frame synchronized with the first clock, into synchronization with the receive frame synchronized with the second clock.

7. The pointer processing apparatus according to claim 6, wherein:
the first synchronizing unit includes a first storage unit to which the receive frame is written in synchronization with the first clock, and from which the receive frame is read in synchronization with the second clock; and
the second synchronizing unit includes a third storage unit to which the timing signal is written in synchronization with writing of the receive frame to the first storage unit, and from which the timing signal is read in synchronization reading of the receive frame from the first storage unit.

8. The pointer processing apparatus according to claim 6, further comprising:
a pointer calculating unit to calculate a pointer in a transmit frame synchronized with the second clock, on the basis of a difference between a count by a specified counter at the timing indicated by the timing signal synchronized by the second synchronizing unit, and a count by the specified counter at a specified timing within the transmit frame, and a pointer value indicated by the pointer byte.

9. A pointer processing method, comprising:
bringing a receive frame synchronized with a first clock into synchronization with a second clock; and
performing stuffing on the receive frame synchronized with the second clock, in accordance with a value of a pointer byte included in the receive frame.

10. The pointer processing method according to claim 9, further comprising:
comparing a phase of the first clock with a phase of the second clock; and
performing stuffing on the receive frame synchronized with the second clock, when a phase difference between the first clock and the second clock does not fall within a specified range.

11. The pointer processing method according to claim 9, further comprising:
writing a payload and an H3 byte of the receive frame to a specified storage unit in synchronization with the first clock;
determining a range of address from which to read data from the specified storage unit in accordance with a value of the pointer byte; and
reading data stored at the determined address in synchronization with the second clock.

12. The pointer processing method according to claim 9, further comprising:
bringing a timing signal indicating a specified timing within the receive frame synchronized with the first clock, into synchronization with the receive frame synchronized with the second clock.

13. The pointer processing method according to claim 12, further comprising:
calculating a pointer in a transmit frame synchronized with the second clock, on the basis of a difference between a count by a specified counter at the timing indicated by the timing signal synchronized with the receive frame synchronized with the second clock, and a count by the specified counter at a specified timing within the transmit frame, and a pointer value indicated by the pointer byte.
